(19) United States
(12) Patent Application Publication
(10) Pub. No.: US 2017/0243166 A1
(43) Pub. Date: Aug. 24, 2017

(54) SYSTEM AND METHOD FOR EMPLOYEE PLACEMENT PREDICTION USING MACHINE LEARNING

(71) Applicant: TEACHER MATCH, LLC, AUSTIN, TX (US)

(72) Inventors: Nicholas Montgomery, Chicago, IL (US); Art Atikune, Austin, TX (US); Ron Huberman, Chicago, IL (US)

(21) Appl. No.: 15/437,572

(22) Filed: Feb. 21, 2017

Related U.S. Application Data
(60) Provisional application No. 62/297,209, filed on Feb. 19, 2016.

(51) Int. Cl. G06Q 10/10; G06N 99/00; G06N 5/04; G06Q 10/06

(52) U.S. Cl. CPC G06Q 10/1053; G06Q 10/067; G06N 99/005; G06N 5/04

(57) ABSTRACT

A method, computer program product, and computer system for identifying, by a computing device, historical information associated with filling a substitute position for a profession, wherein the historical information may include a plurality of categories. At least a first portion of categories of the plurality of categories may be selected to be used in a prediction model. A prediction may be generated for at least one of a number of future substitute positions for the profession that will be available and a number of the future substitute positions for the profession that will be filled.

### RELATED CASES

This application claims the benefit of U.S. Provisional Application No. 62/297,209, filed on 19 Feb. 2016, the contents of which are all incorporated by reference.

### BACKGROUND

Some professions, such as teachers, may have situations where they are unable to come to work and teach their class. For example, a teacher may have vacation days, sick days, or family emergencies that require the teacher to be absent from the class. Generally, when these situations arise, one or more substitute teachers may be contacted to fill the teacher's absence and teach the class. However, at least some of these situations may be unpredictable and “last second” (e.g., sick days, family emergencies, etc.), which may make it difficult to find a substitute teacher.

### BRIEF SUMMARY OF DISCLOSURE

In one example implementation, a method, performed by one or more computing devices, may include but is not limited to identifying, by a computing device, historical information associated with filling a substitute position for a profession, wherein the historical information may include a plurality of categories. At least a first portion of categories of the plurality of categories may be selected to be used in a prediction model. A prediction may be generated for at least one of a number of future substitute positions for the profession that will be available and a number of the future substitute positions for the profession that will be filled.

One or more of the following example features may be included. One or more substitutes to fill a substitute position may be contacted based upon, at least in part, the historical information. The historical information may include at least one of a type of substitute position, a location where the substitute position is posted, a first date when the substitute position is posted compared to a second date when the substitute position was to be filled, and a status of the substitute position after the second date when the substitute position was to be filled. The prediction model for generating the prediction may be selected. Selecting at least the first portion of categories of the plurality of categories to be used in the prediction model may be based upon, at least in part, at least the first portion of categories of the plurality of categories having a higher correlation to filling the substitute position than at least a second portion of categories of the plurality of categories. The prediction may be categorized by type of substitute profession. The prediction may be categorized by at least one of location and date.

In another example implementation, a computing system may include one or more processors and one or more memories configured to perform operations that may include but are not limited to identifying historical information associated with filling a substitute position for a profession, wherein the historical information may include a plurality of categories. At least a first portion of categories of the plurality of categories may be selected to be used in a prediction model. A prediction may be generated for at least one of a number of future substitute positions for the profession that will be available and a number of the future substitute positions for the profession that will be filled.

One or more of the following example features may be included. One or more substitutes to fill a substitute position may be contacted based upon, at least in part, the historical information. The historical information may include at least one of a type of substitute position, a location where the substitute position is posted, a first date when the substitute position is posted compared to a second date when the substitute position was to be filled, and a status of the substitute position after the second date when the substitute position was to be filled. The prediction model for generating the prediction may be selected. Selecting at least the first portion of categories of the plurality of categories to be used in the prediction model may be based upon, at least in part, at least the first portion of categories of the plurality of categories having a higher correlation to filling the substitute position than at least a second portion of categories of the plurality of categories. The prediction may be categorized by type of substitute profession. The prediction may be categorized by at least one of location and date.

In another example implementation, a computer program product may reside on a computer readable storage medium having a plurality of instructions stored thereon which, when executed across one or more processors, may cause at least a portion of the one or more processors to perform operations that may include but are not limited to identifying historical information associated with filling a substitute position for a profession, wherein the historical information may include a plurality of categories. At least a first portion of categories of the plurality of categories may be selected to be used in a prediction model. A prediction may be generated for at least one of a number of future substitute positions for the profession that will be available and a number of the future substitute positions for the profession that will be filled.

One or more of the following example features may be included. One or more substitutes to fill a substitute position may be contacted based upon, at least in part, the historical information. The historical information may include at least one of a type of substitute position, a location where the substitute position is posted, a first date when the substitute position is posted compared to a second date when the substitute position was to be filled, and a status of the substitute position after the second date when the substitute position was to be filled. The prediction model for generating the prediction may be selected. Selecting at least the first portion of categories of the plurality of categories to be used in the prediction model may be based upon, at least in part, at least the first portion of categories of the plurality of categories having a higher correlation to filling the substitute position than at least a second portion of categories of the plurality of categories. The prediction may be categorized by type of substitute profession. The prediction may be categorized by at least one of location and date.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a prediction process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a prediction process according to one or more example implementations of the disclosure; and

FIG. 4 is an example conceptual diagram of a prediction process according to one or more example implementations of the disclosure.

Like reference symbols in the various drawings indicate like elements.

### DETAILED DESCRIPTION

### System Overview:

Some professions, such as teachers, may have situations where they are unable to come to work and teach their class. For example, a teacher may have vacation days, sick days, or family emergencies that require the teacher to be absent from the class. Generally, when these situations arise, one or more substitute teachers may be contacted to fill the teacher's absence and teach the class. However, at least some of these situations may be unpredictable and “last second” (e.g., sick days, family emergencies, etc.), which may make it difficult to find a substitute teacher. As will be discussed in greater detail below, prediction process 10 may implement aspects of a substitute employee placement system and/or a predictive analytics toolset to supply users (e.g., administrators) with information for managing their substitute teacher workforce. Prediction process 10 may use information, such as historical information of individual school districts, to predict where, e.g., a school district, may have a workforce that is too large or too small, which may address issues with achieving greater success and efficiency in placing substitute teachers into empty classrooms.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

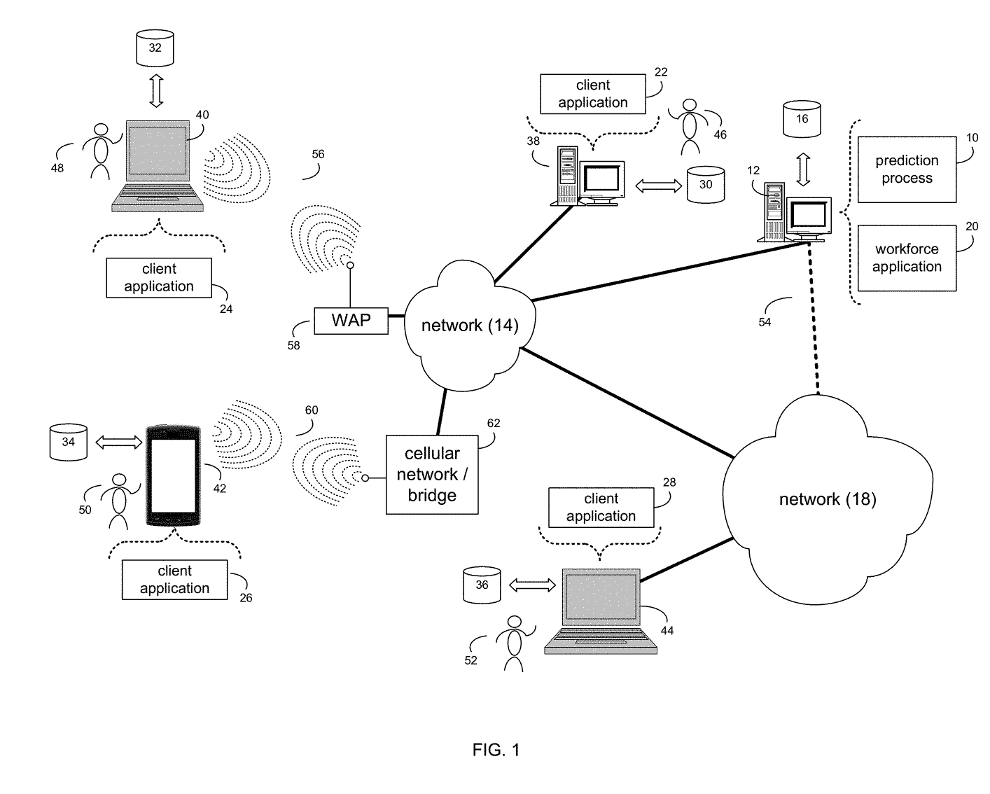

Referring now to the example implementation of FIG. 1, there is shown prediction process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a prediction process, such as prediction process 10 of FIG. 1, may identify historical information associated with filling a substitute position for a profession, wherein the historical information may include a plurality of categories. At least a first portion of categories of the plurality of categories may be selected to be used in a prediction model. A prediction may be generated for at least one of a number of future substitute positions for the profession that will be available and a number of the future substitute positions for the profession that will be filled.

In some implementations, the instruction sets and subroutines of prediction process 10, which may be stored on storage device, such as storage device 16, coupled to computer 12, may be executed by one or more processors (not shown) and one or more memory architectures included within computer 12. In some implementations, storage device 16 may include but is not limited to: a hard disk drive; a flash drive, a tape drive; an optical drive; a RAID array (or other array); a random access memory (RAM); and a read-only memory (ROM).

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, prediction process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a workforce application (e.g., workforce application 20), such as the Workforce Intelligence Response Engine™ (WIRE) application and/or SmartFind™ application provided by TeacherMatch® of Chicago, Ill., or other application that allows for the management of hiring, iterative learning, and predictive analytics (e.g., via machine learning). In some implementations, prediction process 10 and/or workforce application 20 may be accessed via one or more of client applications 22, 24, 26, 28. In some implementations, prediction process 10 may be a standalone application, or may be an applet/application/script/extension that may interact with and/or be executed within workforce application 20, a component of workforce application 20, and/or one or more of client applications 22, 24, 26, 28. In some implementations, workforce application 20 may be a standalone application, or may be an applet/application/script/extension that may interact with and/or be executed within prediction process 10, a component of prediction process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of prediction process 10 and/or workforce application 20. Examples of client applications 22, 24, 26, 28 may include, but are not limited to, e.g., the Workforce Intelligence Response Engine™ (WIRE) application and/or SmartFind™ application provided by TeacherMatch® of Chicago, Ill., or other application that allows for the management of hiring, iterative learning, and predictive analytics (e.g., via machine learning), a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™ Apple® iOS®, Mac® OS X®; Red Hat® Linux®, or a custom operating system.

In some implementations, one or more of client applications 22, 24, 26, 28 may be configured to effectuate some or all of the functionality of prediction process 10 (and vice versa). Accordingly, in some implementations, prediction process 10 may be a purely server-side application, a purely client-side application, or a hybrid server-side/client-side application that is cooperatively executed by one or more of client applications 22, 24, 26, 28 and/or prediction process 10.

In some implementations, one or more of client applications 22, 24, 26, 28 may be configured to effectuate some or all of the functionality of workforce application 20 (and vice versa). Accordingly, in some implementations, workforce application 20 may be a purely server-side application, a purely client-side application, or a hybrid server-side/client-side application that is cooperatively executed by one or more of client applications 22, 24, 26, 28 and/or workforce application 20. As one or more of client applications 22, 24, 26, 28, prediction process 10, and workforce application 20, taken singly or in any combination, may effectuate some or all of the same functionality, any description of effectuating such functionality via one or more of client applications 22, 24, 26, 28, prediction process 10, workforce application 20, or combination thereof, and any described interaction(s) between one or more of client applications 22, 24, 26, 28, prediction process 10, workforce application 20, or combination thereof to effectuate such functionality, should be taken as an example only and not to limit the scope of the disclosure.

In some implementations, one or more of users 46, 48, 50, 52 may access computer 12 and prediction process 10 (e.g., using one or more of client electronic devices 38, 40, 42, 44) directly through network 14 or through secondary network 18. Further, computer 12 may be connected to network 14 through secondary network 18, as illustrated with phantom link line 54. Prediction process 10 may include one or more user interfaces, such as browsers and textual or graphical user interfaces, through which users 46, 48, 50, 52 may access prediction process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

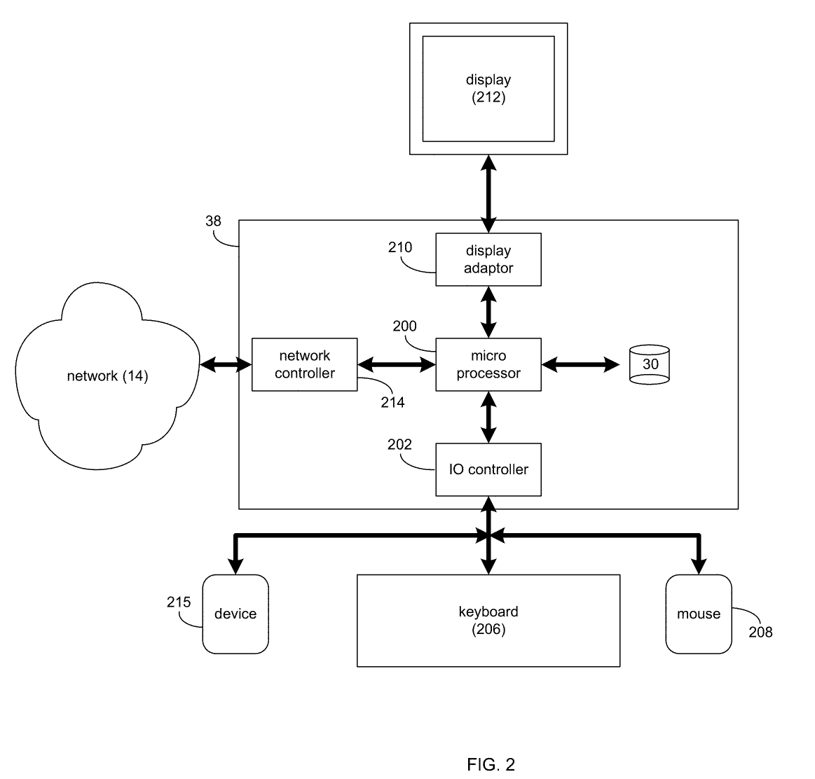

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, prediction process 10 may be substituted for client electronic device 38 (in whole or in part) within FIG. 2, examples of which may include but are not limited to computer 12 and/or one or more of client electronic devices 38, 40, 42, 44.

In some implementations, client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., touchpad, touchscreen, mouse 208, etc.), custom device (e.g., device 215), USB ports (not shown), and printer ports (not shown). A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

As will be discussed below, prediction process 10 may at least help, e.g., improve existing technological processes associated with, e.g., predictive analytics for hiring substitute teachers necessarily rooted in computer technology in order to overcome problems specifically arising in the realm of computer networks utilizing predictive analytics for hiring substitute teachers.

The Prediction Process:

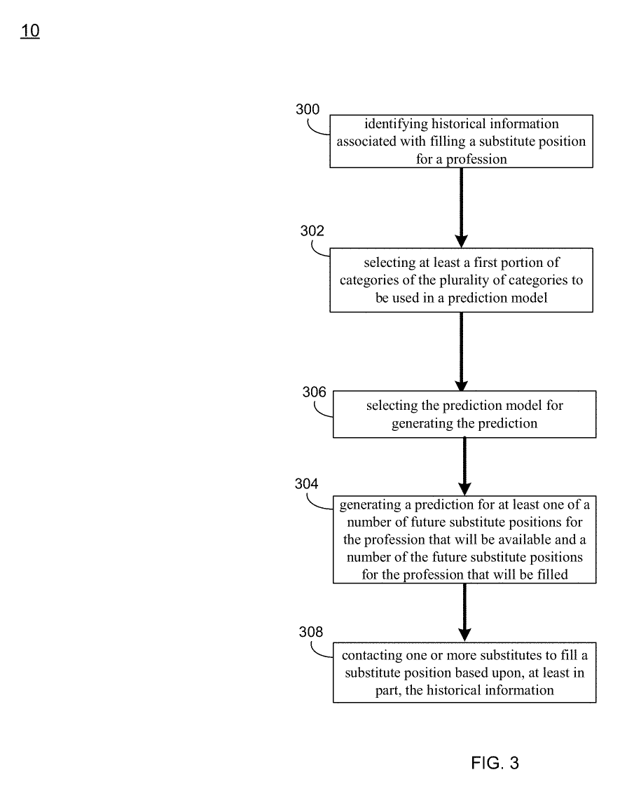

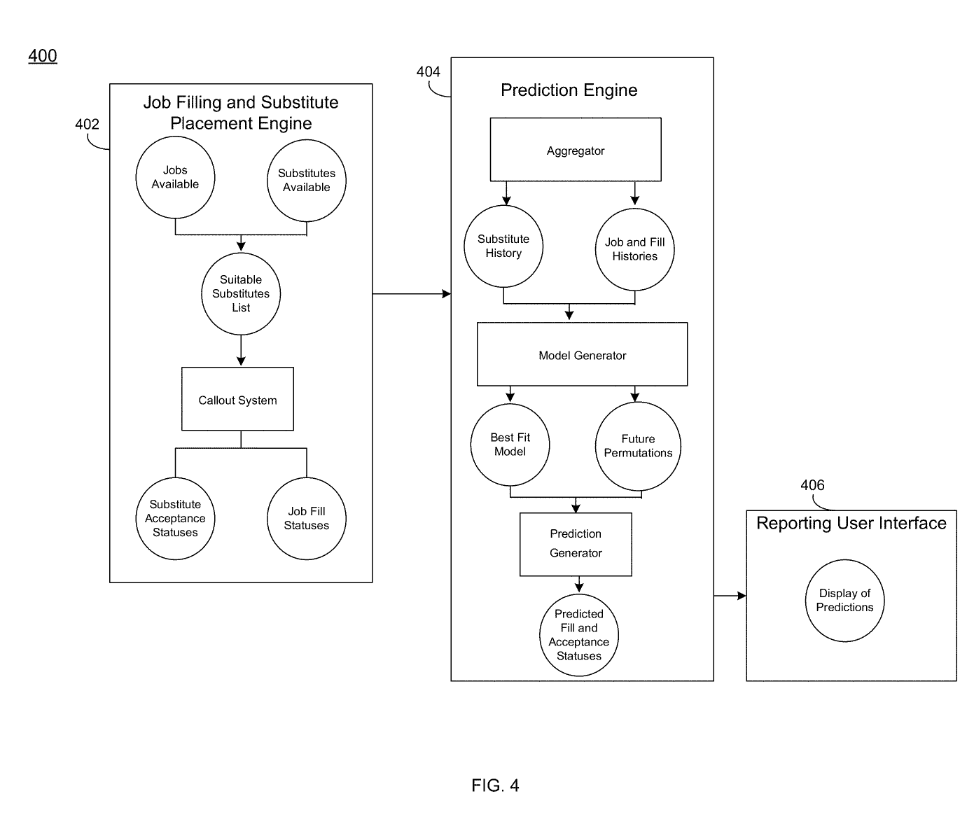

As discussed above and referring also at least to the example implementations of FIGS. 3-4, prediction process 10 may identify 300 historical information associated with filling a substitute position for a profession, wherein the historical information may include a plurality of categories. Prediction process 10 may select 302 at least a first portion of categories of the plurality of categories to be used in a prediction model. Prediction process 10 may generate 304 a prediction for at least one of a number of future substitute positions for the profession that will be available and a number of the future substitute positions for the profession that will be filled.

For simplicity, the present disclosure is described using teachers as the profession; however, it will be appreciated that any other profession may be used without departing from the scope of the disclosure. As such, the description of a teacher should be used as an example only and not to otherwise limit the scope of the disclosure.

In some implementations, and referring at least to example FIG. 4, an example conceptual diagram 400 of one or more aspects of prediction process 10 is shown. In the example, prediction process 10 may include, e.g., a job filling and substitute placement engine, a prediction engine, and reporting user interface, each of which will be described in greater detail below.

In some implementations, prediction process 10 may identify 300 historical information associated with filling a substitute position for a profession, wherein the historical information may include a plurality of categories. For example, job filling and substitute placement engine 402 of prediction process 10 may match available job opportunities with substitutes, and may offer the jobs to the substitutes through, e.g., the Internet or via phone (IVR), or other suitable technique. Prediction process 10 may follow a user configurable search rule to determine the order in which substitutes should be called and whether necessary qualifications have been met. After a successful match is found by prediction process 10, prediction process 10 may offer the substitute the job opportunity through, e.g., an automated phone call, online via website, smartphone application, email, text message, or other suitable technique. Prediction process 10 may enable the substitute to accept or decline the job offer. In the event that the substitute declines the offer, prediction process 10 may continue matching and offering jobs until a substitute accepts the job offer. Detailed records may be maintained by prediction process 10 of a substitute's acceptance of offers and whether jobs were filled.

As another example, assume for example purposes only that when a substitute teacher is required, a “post” or other notification (e.g., email, text message, automated phone call, etc.) that a substitute teacher is required is generated (e.g., via prediction process 10). In the example, the post may include a description and/or requirements of the type of substitute position required for the substitute teacher (e.g., math substitute, special education substitute, etc.), a location where the substitute position is posted (e.g., school, school district, geographical location, etc.), the date when the post is posted, the date when the substitute position is to be filled, and whether or not the substitute position has been filled. As noted above, detailed records of historical information (e.g., over the last 1-3 years or more) associated with each post may be stored in a data store, which may be located on a storage device, such as storage device 16. In the example, prediction process 10 may identify 300 the above-noted historical information, which may include prediction process 10 receiving/requesting the historical information from storage device 16.

As noted above, in some implementations, the historical information may include at least one of a type of substitute position, a location where the substitute position is posted, a first date when the substitute position is posted compared to a second date when the substitute position was to be filled, and a status of the substitute position after the second date when the substitute position was to be filled. For example, the historical information may include the type of substitute position required for the substitute teacher (e.g., math substitute, special education substitute, etc.). As another example, the historical information may include the location where the substitute position is posted (e.g., school, school district, geographical location, etc.). As yet another example, the historical information may include the date when the post is (was) posted and the date when the substitute position is (was) to be filled, which may be compared by prediction process 10. For instance, if the date when the post was posted was on a Monday for a particular week, and the date when the substitute position was to be filled was a Wednesday for that same week, prediction process 10 may compare the two dates and determine that there were two days from when the post was posted and when the substitute position was to be filled.

As yet another example, the historical information may include status of the substitute position after the second date when the substitute position was to be filled. For instance, if after the date when the substitute position was to be filled has passed and the substitute position was filled, the status may include a “filled” status. Conversely, if after the date when the substitute position was to be filled has passed and the substitute position was not filled, the status may include a “not filled” status. It will be appreciated that other types of historical information may be included without departing from the scope of the disclosure. For example, the historical information may indicate whether the date when the post was posted (and/or the date when the substitute position was to be filled) was on a holiday, as well as what holiday. Therefore, the example historical information described should be taken as example only and not to limit the scope of the disclosure.

In some implementations, prediction process 10 may select 302 at least a first portion of categories of the plurality of categories to be used in a prediction model. In some implementations, selecting 302 at least the first portion of categories of the plurality of categories to be used in the prediction model may be based upon, at least in part, at least the first portion of categories of the plurality of categories having a higher correlation to filling the substitute position than at least a second portion of categories of the plurality of categories. For example, drawing upon the automatically generated data from job filling and substitute placement engine 402, prediction engine 404 of prediction process 10 may, e.g., automatically, determine and select 302 the most important components (e.g., categories) affecting fill rates. For example, through a combination of aggregating substitute history, job and fill history (as well as any other categories from the above-noted historical information) by, example categories such as, e.g., organization, location, classifications, along with district characteristics, prediction engine 404 may determine and select 302 which factors (e.g., categories) may have the largest effect on fill rates and a substitute's likelihood of accepting a call.

For instance, assume for example purposes only that the historical information may be categorized according to, e.g., (1) a type of substitute position, (2) a location where the substitute position is posted, and (3) a first date when the substitute position is posted compared to a second date when the substitute position was to be filled. Further assume in the example that prediction process 10 has determined that category (1) and category (3) are the two categories of historical information that have the highest correlation to whether or not posts about available substitute positions are filled. Further assume in the example that by comparison, prediction process 10 has determined that category (2) has less of a correlation to whether or not posts about available substitute positions are filled. In the example, prediction process 10 may select 302 category (1) and category (3) to be used in a prediction model and leave out category (2) from use in the prediction model.

In some implementations, prediction process 10 may use some or all categories in the prediction model, but weigh each category based upon, at least in part, correlation to whether or not posts about available substitute positions are filled.

In some implementations, prediction process 10 may feed the learning data set into a lasso regression for selecting features that predict the outcome. The maximum set of features may be run initially and may define the initial variance accounted for (σ). The set of features (e.g., categories) may be reduced by recursively pruning the feature with the smallest standardized coefficient and rerunning the models until the variance accounted for is less than a threshold (t) within the original variance (prune while σ−σ′<t). A standard setting for the threshold may be 1% of the original variance σ, although other thresholds may be used. Once the threshold is passed, the feature-set with the fewest features while still staying within the threshold is the final selection of features. This process at times may determine that there are a large number of predictors or a limited number of predictors.

In some implementations, the prediction model for generating 304 the prediction may be selected 306 by prediction process 10. For example, in some implementations, prediction process 10 may test multiple possible models and may select 306 the one with the best prediction results. In the example, that model may result in a set of coefficients that may be used to make future prediction. Prediction process 10 may pair the model results with a set of future permutations to predict and feed into an associated prediction generator of prediction process 10. In some implementations, once feature selection is complete, multiple models may be tested by prediction process 10 using the selected features, and the model with the strongest prediction may be used for calculating weights (as noted above). The potential models may include, e.g., linear regression (ordinary least squares), ridge regression, lasso regression, elastic net, logistic regression, and others. The output from the selection process may be a set of coefficients (or weights) that may determine the relationship between each feature and the outcome (acceptance of a job, fill rate, etc.). Those coefficients from historical performance and the average performance β₀ may be saved in the database for use in the prediction. The coefficients β may then used by prediction process 10 to produce predictions for a set of future conditions and permutations. For example, an individual substitute may have a set (n) values (v) for each of the features. The prediction for that substitute's likelihood of accepting a job may be β₀+Σk=1 to n (Vₖβₖ). The same formula structure may be applied to other prediction steps.

In some implementations, prediction process 10 may generate 304 a prediction for at least one of a number of future substitute positions for the profession that will be available and a number of the future substitute positions for the profession that will be filled. For example, the output from the associated prediction generator may include generated 304 predictions for, e.g., the likely number of jobs that may be available in the future, fill rates of those future jobs, and/or acceptance statuses for teachers. In some implementations, this process may be manually and/or automatically run on a predefined frequency, both to update the prediction models with new information and to update the predictions themselves, which may include determining and selecting 302 different components (e.g., categories) that most affect fill rates, changing weights applied to each category, etc.

In some implementations, the prediction may be categorized by at least one of location and date. For example, in some implementations, prediction user interface 406 of prediction process 10 may draw from the prediction results to provide a daily, monthly, etc. display of predictions, e.g., in a calendar view. In some implementations, the display may clearly highlight days, weeks, months, etc. that could be problems for filling jobs. Users (e.g., administrators) may be able to diagnose the reasons based on the expected number of jobs that need to be filled, the number of teachers available to fill, the expected acceptance rates, etc. In some implementations, the daily views may be aggregated manually and/or automatically into a month by month view to highlight problem months, as well as allowing users to search and view for specific locations and classifications that may be problematic.

In some implementations, the prediction may be categorized by type of substitute profession. For example, prediction user interface 406 of prediction process 10 may draw from the prediction results to provide a daily, monthly, etc. display of predictions organized by the category type of substitute profession, e.g., in a calendar view. In some implementations, the display may clearly highlight days, weeks, months, etc. that could be problems for filling jobs by the type of substitute profession. Users (e.g., administrators) may be able to diagnose the reasons based on the expected number of jobs that need to be filled by the type of substitute profession, the number of teachers by the type of substitute profession available to fill, the expected acceptance rates by the type of substitute profession, etc. In some implementations, the daily views may be aggregated manually and/or automatically into a month by month view to highlight problem months by the type of substitute profession, as well as allowing users to search for specific locations and classifications that may be problematic by the type of substitute profession.

In some implementations, one or more substitutes to fill a substitute position may be contacted 308 by prediction process 10 based upon, at least in part, the historical information. For example, prediction process 10 may integrate a substitutes likely acceptance of a substitute position offered at a particular location into a call (or other contacting technique) prioritization. For instance, those substitutes that are predicted by prediction process 10 as most likely to accept a substitute position when called (or otherwise contacted) may be contacted 308 first. Those substitutes that are predicted by prediction process 10 as less likely to a substitute position when called (or otherwise contacted) may be contacted 308 later.

For instance, assume for example purposes only that, e.g., 5 substitutes (substitute 1, substitute 2, . . . substitute 5) are on a list of substitutes to be called by prediction process 10 to fill a substitute position. In the example, further assume that prediction process 10 predicts the following likelihood of acceptance for each substitute as follows: substitute 1—0.5, substitute 2—0.4, substitute 3—0.6, substitute 4—0.1, substitute 5—0.9. Thus, in the example, prediction process 10 may contact 308 call the substitutes in the following order based upon their likelihood of acceptance: substitute 5, substitute 3, substitute 1, substitute 2, and substitute 4.

In some implementations, prediction process 10 may balance candidates who have not been called for any jobs at that location and may appropriately locate their priority in the queue. For example, prediction process 10 may assign such candidates a probability equal to the average probability within the system (β₀).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying, by a computing device, historical information associated with filling a substitute position for a profession, wherein the historical information includes a plurality of categories;
selecting at least a first portion of categories of the plurality of categories to be used in a prediction model; and
generating a prediction for at least one of a number of future substitute positions for the profession that will be available and a number of the future substitute positions for the profession that will be filled.

2. The computer-implemented method of claim 1 further comprising contacting one or more substitutes to fill a substitute position based upon, at least in part, the historical information.

3. The computer-implemented method of claim 1 wherein the historical information includes at least one of a type of substitute position, a location where the substitute position is posted, a first date when the substitute position is posted compared to a second date when the substitute position was to be filled, and a status of the substitute position after the second date when the substitute position was to be filled.

4. The computer-implemented method of claim 1 further comprising selecting the prediction model for generating the prediction.

5. The computer-implemented method of claim 1 wherein selecting at least the first portion of categories of the plurality of categories to be used in the prediction model is based upon, at least in part, at least the first portion of categories of the plurality of categories having a higher correlation to filling the substitute position than at least a second portion of categories of the plurality of categories.

6. The computer-implemented method of claim 1 wherein the prediction is categorized by type of substitute profession.

7. The computer-implemented method of claim 1 wherein the prediction is categorized by at least one of location and date.

8. A computer program product residing on a computer readable storage medium having a plurality of instructions stored thereon which, when executed across one or more processors, causes at least a portion of the one or more processors to perform operations comprising:
identifying historical information associated with filling a substitute position for a profession, wherein the historical information includes a plurality of categories;
selecting at least a first portion of categories of the plurality of categories to be used in a prediction model; and
generating a prediction for at least one of a number of future substitute positions for the profession that will be available and a number of the future substitute positions for the profession that will be filled.

9. The computer program product of claim 8 further comprising contacting one or more substitutes to fill a substitute position based upon, at least in part, the historical information.

10. The computer program product of claim 8 wherein the historical information includes at least one of a type of substitute position, a location where the substitute position is posted, a first date when the substitute position is posted compared to a second date when the substitute position was to be filled, and a status of the substitute position after the second date when the substitute position was to be filled.

11. The computer program product of claim 8 further comprising selecting the prediction model for generating the prediction.

12. The computer program product of claim 8 wherein selecting at least the first portion of categories of the plurality of categories to be used in the prediction model is based upon, at least in part, at least the first portion of categories of the plurality of categories having a higher correlation to filling the substitute position than at least a second portion of categories of the plurality of categories.

13. The computer program product of claim 8 wherein the prediction is categorized by type of substitute profession.

14. The computer program product of claim 8 wherein the prediction is categorized by at least one of location and date.

15. A computing system including one or more processors and one or more memories configured to perform operations comprising:
identifying historical information associated with filling a substitute position for a profession, wherein the historical information includes a plurality of categories;
selecting at least a first portion of categories of the plurality of categories to be used in a prediction model; and
generating a prediction for at least one of a number of future substitute positions for the profession that will be available and a number of the future substitute positions for the profession that will be filled.

16. The computing system of claim 15 further comprising contacting one or more substitutes to fill a substitute position based upon, at least in part, the historical information.

17. The computing system of claim 15 wherein the historical information includes at least one of a type of substitute position, a location where the substitute position is posted, a first date when the substitute position is posted compared to a second date when the substitute position was to be filled, and a status of the substitute position after the second date when the substitute position was to be filled.

18. The computing system of claim 15 further comprising selecting the prediction model for generating the prediction.

19. The computing system of claim 15 wherein selecting at least the first portion of categories of the plurality of categories to be used in the prediction model is based upon, at least in part, at least the first portion of categories of the plurality of categories having a higher correlation to filling the substitute position than at least a second portion of categories of the plurality of categories.

20. The computing system of claim 15 wherein the prediction is categorized by type of substitute profession.

21. The computing system of claim 15 wherein the prediction is categorized by at least one of location and date.
